(19) United States
(12) Patent Application Publication
(10) Pub. No.: US 2026/0143406 A1
(43) Pub. Date: May 21, 2026

(54) SYSTEMS AND METHODS FOR DYNAMIC SHORT CODES IN A WIRELESS NETWORK

(71) Applicant: Verizon Patent and Licensing Inc., Basking Ridge, NJ (US)

(72) Inventors: Kashif Khan, Keller, TX (US); Danysel Barthelme, Frisco, TX (US); Daniel L. Walker, Wall Township, NJ (US); Shujaat Ali Siddique, Hillsborough, NJ (US)

(73) Assignee: Verizon Patent and Licensing Inc., Basking Ridge, NJ (US)

(21) Appl. No.: 18/953,720

(22) Filed: Nov. 20, 2024

(51) Int. Cl. H04W 40/22; H04W 4/14; H04W 8/04; H04W 48/16

(52) U.S. Cl. CPC H04W 40/22; H04W 4/14; H04W 8/04; H04W 48/16

(57) ABSTRACT

A system described herein may maintain a set of policies associated with a plurality of codes; receive a communication from a User Equipment ("UE"), that includes a particular code of the plurality of codes; identify a particular policy, of the set of policies, associated with the particular code; receive, from a particular wireless network, network information associated with the UE; identify a route for the communication based on the particular policy and the received network information; and route the communication based on the route that was identified based on the particular policy and the received network information. The codes may include short codes that include fewer digits than Mobile Directory Numbers ("MDNs") that are also used by the wireless network to route communications.

### BACKGROUND

Wireless networks provide wireless connectivity to User Equipment ("UEs"), such as mobile telephones, tablets, Internet of Things ("IoT") devices, Machine-to-Machine ("M2M") devices, or the like. One service provided by a wireless network may include voice call services, such as Voice over Internet Protocol ("VoIP") services. Another service may include short Message Service ("SMS") messaging, sometimes known as "texting." Some wireless networks may allow voice calls and/or SMS messaging using "short codes," in which sequences of digits that are shorter than phone numbers such as Mobile Directory Numbers ("MDNs") used for the purposes of initiating voice calls or for SMS messaging. Examples of such short codes may include 911 for emergency, 411 for information, and so on.

### BRIEF DESCRIPTION OF THE DRAWINGS

FIGS. 1-3 illustrate example dynamic short code-based communication routing of one or more embodiments described herein;

FIGS. 4 and 5 illustrate example communications between network devices to implement dynamic short code-based communication routing, in accordance with some embodiments;

FIG. 6 illustrates an example process for dynamic short code-based communication routing, in accordance with some embodiments;

FIGS. 7 and 8 illustrate example environments in which one or more embodiments, described herein, may be implemented;

FIG. 9 illustrates an example arrangement of a radio access network ("RAN"), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for dynamic short codes for communications (e.g., voice calls, SMS messages, and/or other types of communications) in a wireless network. As noted above, a short code may be a code (e.g., a sequence of digits or other characters (e.g., symbols, letters, or the like), such as four digits or characters, five digits or characters, or the like) used for indicating a communication endpoint, such as a recipient of a voice call or of an SMS message. The short code may be shorter than (e.g., contains fewer digits or characters than) other codes or numbers (e.g., MDNs, phone numbers, or the like) that are used for communications via the wireless network, such as voice calls, text messaging (e.g., some SMS messaging may be implemented without short codes), or the like. Short codes may, additionally, or alternatively, include different formats than other codes. For example, in one implementation, an MDN may be made up of only numerals, while a short code may include other types of characters such as a pound sign (#), an asterisk or star (*), or the like.

When receiving a communication (e.g., a voice call request or an SMS message) directed to a particular short code, for example, the wireless network may determine appropriate routing for the communication, which may include identifying a "long" code or a "full" code, such as an MDN, an Internet Protocol ("IP") address, a Session Initiation Protocol ("SIP") address, or the like, and may proceed to route the communication to its destination based on the identified "long" code or "full" code. In this manner, a sender or initiator of the communication (e.g., a user of a UE) may be able to more conveniently communicate with certain destinations without needing to memorize or otherwise use, for example, a full 10-digit MDN.

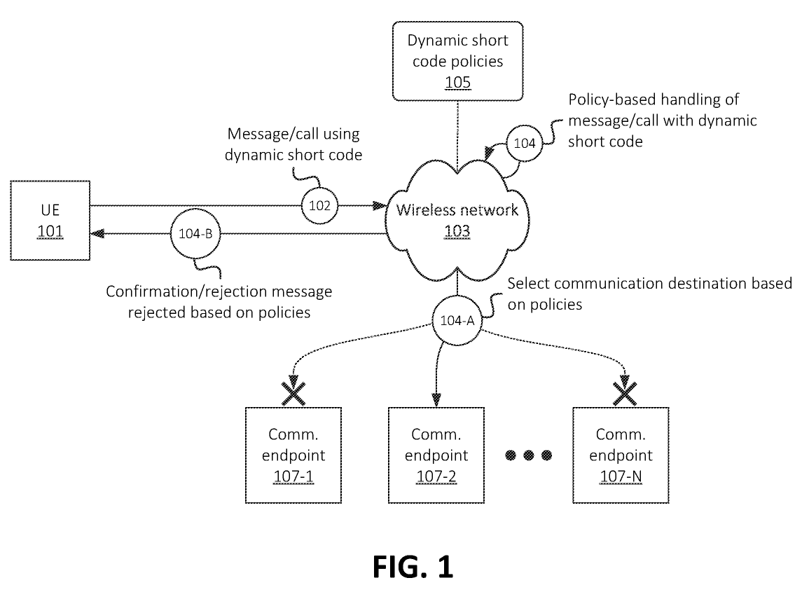

In accordance with some embodiments, and as described herein, a "dynamic" short code may be a short code that facilitates the use of policy-based messaging mechanisms, such as policy-based routing, access control, content filtering, content augmentation, or the like. FIGS. 1-3 illustrate examples of such policy-based communication routing mechanisms that may be implemented in accordance with some embodiments. As shown in FIG. 1, for example, UE 101 may initiate (at 102) a communication (e.g., initiate a voice call and/or send a message, such as an SMS message) via a particular wireless network 103. Wireless network 103 may, for example, be a wireless network to which UE 101 is wirelessly connected, and/or may be a "home" network with which UE 101 is registered or provisioned. As discussed below, wireless network 103 may include or may be communicatively coupled to one or more devices or systems that route, process, etc. voice calls and/or SMS messages, such as a Telephony Application Server ("TAS"), an SMS Center ("SMSC"), an IP Multimedia Subsystem ("IMS") network, or the like.

As additionally shown, wireless network 103 may receive, generate, maintain, etc. a set of dynamic short code policies 105. For example, a mobile network operator ("MNO") that owns, operates, configures, etc. wireless network 103 may provide dynamic short code policies 105 to one or more elements of wireless network 103. Additionally, or alternatively, wireless network 103 may include, or may be communicatively coupled to, a device or system that automatically (e.g., using artificial intelligence/machine learning ("AI/ML") techniques or other automated techniques) generates or modifies dynamic short code policies 105. In this sense, dynamic short code policies 105 may be changed "on the fly" or may be updated in an ongoing manner. As a result, the routing and/or other processing of messages that include short codes may therefore also be able to be changed or updated in a dynamic manner, thus enhancing the flexibility and configurability of wireless network 103.

Dynamic short code policies 105 may specify routing policies, content filtering policies, usage-based policies, location-based policies, and/or other types of policies for different short codes. For example, dynamic short code policies 105 may specify particular short codes to which particular respective policies are applicable. Additionally, or alternatively, dynamic short code policies 105 may specify prefixes, regular expressions, partial short codes, etc. to which particular respective policies are applicable. As one example, a prefix of #12 may be specified for a given policy or set of policies. In this example, short codes that include #12 as the first three characters may be short codes to which such policies are applicable.

Dynamic short code policies 105 may, in some embodiments, specify criteria, conditions, attributes, etc., in addition to short codes themselves, that specify when a given policy is applicable. For example, one or more dynamic short code policies 105 may include temporal conditions (e.g., policies that are applicable or active during certain times of day, day of the week, season, etc.), location-based conditions (e.g., policies that are applicable when UE 101 is at a particular location), UE attribute conditions (e.g., policies that are applicable when UE 101 is a given device type, when UE is associated with a particular category or group, and/or based on other UE attributes), usage-based conditions (e.g., based on a quantity of SMS messages sent to a given short code within a given timeframe), and/or other suitable conditions. In some embodiments, dynamic short code policies 105 may be set on a per-UE basis, where different sets of dynamic short code policies 105 are applicable to different UEs 101 (e.g., a first UE 101 may be permitted to send multiple messages to a given short code within a given time period, whereas a second UE may only be permitted to send one message to a given short code within the same time period). In some embodiments, the criteria for a given dynamic short code policy 105 may further include conditions or criteria relating to message content (e.g., one or more key words, phrases, etc. included in SMS messages received from UE 101).

Such conditions may relate to information that is generated by, received by, or is otherwise available to wireless network 103. For example, one or more NFs of wireless network 103 (e.g., an HSS, a UDM, a UDR, an Access and Mobility Management Function ("AMF"), a Mobility Management Entity ("MME"), etc.) may generate or maintain some or all of the information. Additionally, or alternatively, wireless network 103 may receive information from UE 101, which wireless network 103 may use to identify applicable policies. Additionally, or alternatively, wireless network 103 may be communicatively coupled to one or more external devices or systems that provide information that wireless network 103 may use to identify applicable policies.

Wireless network 103 may handle (at 104) the message received from UE 101 based on dynamic short code policies 105. For example, wireless network 103 may identify that the message specifies (or otherwise matches) a particular short code specified in dynamic short code policies 105. Wireless network 103 may determine one or more other factors or attributes, such as temporal conditions, UE location information, UE device type, and/or other information (e.g., as discussed above).

Handling (at 104) the communication (e.g., voice call request, SMS message, etc.) based on an appropriate policy may, as shown in FIG. 1, include selecting (at 104-A) a communication endpoint or route for the communication. Wireless network 103 may have identified, for example, that a particular policy associated with the short code included in the communication is applicable to the communication. For example, UE 101 may be at a particular location specified by the policy (e.g., within a particular tracking area ("TA") of a RAN of wireless network 103, within a particular geographical region, within a venue such as a stadium, etc.). As another example, the communication may be received from UE 101 within a timeframe specified by the policy (e.g., within a specific time range, during a scheduled event such as a sporting event or a concert, or the like). Additionally, or alternatively, wireless network 103 may identify that the policy is applicable based on one or more other factors, as similarly described above.

In this example, wireless network 103 may select communication endpoint 107-2 (e.g., out of a set of candidate message destinations that include communication endpoint 107-1, communication endpoint 107-2, communication endpoint 107-N, and so on). For example, the identified policy may indicate that when certain conditions are met (e.g., temporal conditions, UE attribute conditions, etc.), that communications that include the particular short code should be routed to communication endpoint 107-2. Communication endpoints 107 may each be implemented as different devices or systems, and/or may otherwise be associated with different addressing or routing (e.g., different MDNs, different IP addresses, different SIP addresses, or the like).

Routing the communication to communication endpoint 107-2 may include, in some embodiments, performing or facilitating a voice call setup between UE 101 and communication endpoint 107-2. For example, in situations where the communication (received at 102) includes a voice call request, wireless network 103 may generate one or more protocol messages (e.g., a SIP INVITE message that includes an IP address or other identifier of communication endpoint 107-2) to facilitate a voice call setup between UE 101 and communication endpoint 107-2. As referred to herein, a "voice call request" may refer to a dialed number (e.g., using a telephone application or other suitable application) that may be used to indicate the initiation or request to initiate a voice call. In some situations, the outputting of the voice call request, as discussed herein, may be independent of an actual established voice call. That is, the actual establishment of a voice call may not be necessary in accordance with some embodiments, and the voice call request itself (e.g., the dialing of a dynamic short code, which may include or may be associated with a SIP INVITE message or other suitable indication) may be a communication based on which a policy-based handling is performed, in accordance with some embodiments.

As another example, in situations where the communication (received at 102) includes an SMS message along with the short code, wireless network 103 may determine that such SMS message should be forwarded to communication endpoint 107-2. As yet another example, the communication (received at 102) may include a first type of communication (e.g., a voice call request), and wireless network 103 may generate and/or forward a different type of communication (e.g., an SMS message or other type of notification in response to a dialed dynamic short code) to communication endpoint 107-2, such as a notification that a voice call request was received from UE 101.

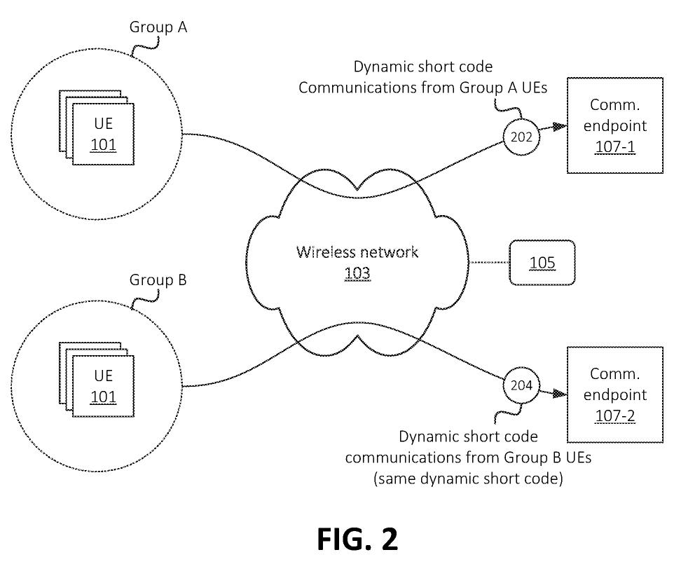

In the presence of different conditions, the same short code may be used to route communications (e.g., voice call requests, SMS messages, and/or other types of communications) to different communication endpoints 107, and/or to otherwise process or handle such communications in different manners. For example, as shown in FIG. 2, assume that wireless network 103 receives communications (e.g., voice call requests or SMS messages) from different UEs 101 or sets of UEs 101 (shown as "Group A" and "Group B"). The first set of UEs 101 (e.g., Group A) may include UEs that are located in a first location, UEs that are associated with a first category or label, UEs that are associated with a first device type (e.g., IoT device, smartphone, M2M device, etc.), and/or are UEs that are otherwise associated with a first set of attributes. The second set of UEs 101 (e.g., Group B) may include UEs that are located in a second location, UEs that are associated with a second category or label, UEs that are associated with a second device type, and/or UEs that are otherwise associated with a second set of attributes that is different from the attributes of the first set of UEs.

Wireless network 103 may receive communications that include or specify a given short code from UEs 101 of Group A and/or Group B, and may route such communications differently based on dynamic short code policies 105. For example, wireless network 103 may route (at 202) communications, that include a particular short code and which are received from UEs 101 of Group A, to communication endpoint 107-1 based on dynamic short code policies 105. On the other hand, wireless network 103 may route (at 204) communications, that include the same short code and which are received from UEs 101 of Group B, to communication endpoint 107-2 based on dynamic short code policies 105. In this manner, the same short code may be used for multiple different communication endpoints 107, thus adding flexibility to the implementation of dynamic short codes in wireless network 103.

In one example, UEs 101 of Group A may be associated with a first MNO or home network, and UEs 101 of Group B may be associated with a second MNO or home network. In some embodiments, communication endpoint 107-1 may be a device or system associated with the first MNO (e.g., an SMSC, a TAS, a provisioning system, etc. associated with the first MNO), and communication endpoint 107-2 may be a device or system associated with the second MNO. The communications from UEs 101 may include, for example, requests for services or subscription modifications that are provided by or otherwise implemented by the respective home networks of UEs 101. In this manner, wireless network 103 may be able to properly route MNO-specific communications, such as requests to add or modify MNO-provided services, to appropriate MNOs even in situations where wireless network 103 is not a home network of UEs 101.

Returning to FIG. 1, handling (at 104) the communication from UE 101 may include, in some circumstances, providing (at 104-B) a confirmation message, a rejection message, or some other type of response message in response to the communication (received at 102). In one example, the communication (at 102) includes an SMS message, and wireless network 103 may determine (at 104) based on one or more policies, that the SMS message should be rejected. Rejecting the SMS message may include, for example, not forwarding the SMS message to a given communication endpoint 107. For example, wireless network 103 may identify a particular policy associated with the dynamic short code, and may determine that one or more factors specified in the policy indicate that the message should be rejected. For example, the policy may indicate that messages sent from certain UEs 101, and which further include a specific short code, should be rejected (e.g., should not be forwarded to one or more communication endpoints 107), that messages sent from UEs 101 in a certain location should be rejected, that messages sent from UEs 101 that are not in a certain location should be rejected, that messages sent outside of a specified time period should be rejected, that messages that include certain content (e.g., certain words or phrases) should be rejected, or the like.

As another example, wireless network 103 may output a confirmation to UE 101, indicating that a voice call request (received at 102) was received. In one implementation, the voice call request itself (e.g., specifying a particular dynamic short code) may correspond to a request for a service, a "ping," and/or some other type of UE-initiated notification. Wireless network 103 may perform one or more operations, such as providing a service to UE 101 (e.g., via an application server or via a Network Function ("NF") of wireless network 103), modifying UE information (e.g., in a UE information repository such as a Home Subscriber Server ("HSS"), a Unified Data Management function ("UDM"), or a Unified Data Repository ("UDR")), notifying an external device that a call request was received from UE 101, or the like. Wireless network 103 may, in accordance with a corresponding dynamic short code policy, output (at 104-B) a notification such as an SMS message or other type of notification to UE 101, indicating that the voice call request was received and that one or more corresponding actions were performed.

As noted above, in some embodiments, wireless network 103 may output different responses to UEs 101, in accordance with a corresponding dynamic short code policy, based on UE attributes such as location, device type, UE category, or the like. For example, a first UE 101, located in a first geographical location (e.g., a first TA, a first venue, a first cell of a wireless network, etc.) may output a communication (e.g., a voice call, SMS message, etc.) to a particular dynamic short code, and wireless network 103 may provide location-specific information (e.g., an SMS message, a voice call, and/or some other type of communication) to the first UE 101, such as weather or traffic conditions, event information, and/or other information associated with the first geographical location. On the other hand, a second UE 101, located in a second geographical location (e.g., a second TA, a second venue, a second cell of a wireless network, etc.) may output a communication to the same particular dynamic short code, and wireless network 103 may provide location-specific information (e.g., an SMS message, a voice call, and/or some other type of communication) to the second UE 101, such as weather or traffic conditions, event information, and/or other information associated with the second geographical location.

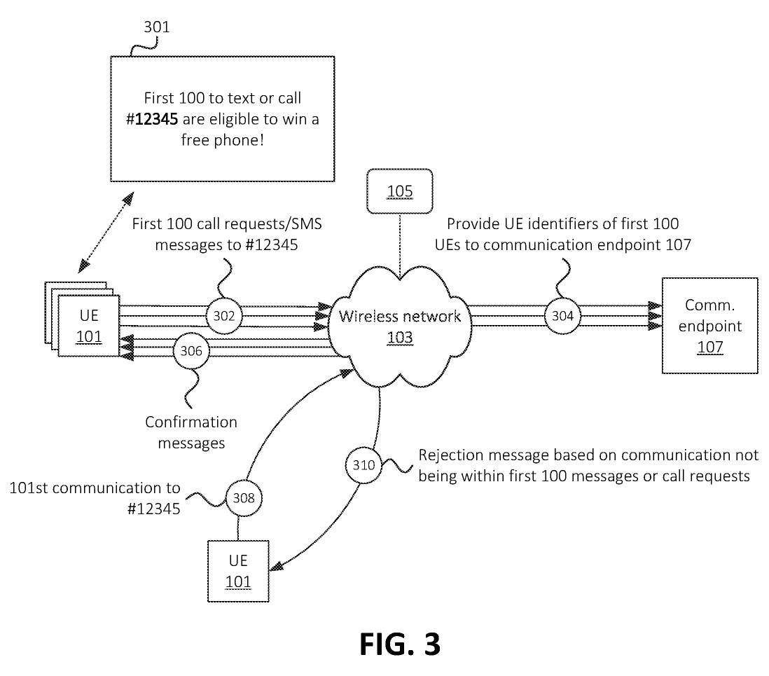

FIG. 3 illustrates an example of dynamic short code policies 105 indicating usage-based policies associated with a given short code. For example, dynamic short code policies 105 may specify that a particular quantity of communications (e.g., voice call requests and/or SMS) messages to a given short code are permitted, after which the short code is no longer usable. In this example, assume that the first 100 communications directed to a particular short code #12345 are permitted. This policy may be provided to one or more UEs 101 or users via notification 301. Notification 301 may be provided to a set of UEs 101 via a system-level or pop-up notification, an email, an SMS message, or the like. In some embodiments, notification 301 may be presented in some other manner (e.g., via a device other than UEs 101), such as via a television broadcast, a content streaming broadcast, or the like.

In this example, a set of UEs 101 may output (at 302) respective communications, such as SMS messages and/or dialed call requests, that specify the particular short code (e.g., #12345). wireless network 103 may identify, based on dynamic short code policies 105, that these communications include the specified short code. In this example, a corresponding dynamic short code policy 105 may specify that a particular communication endpoint 107, such as an application server, should be notified of the respective UEs 101 from which the first 100 communications were received. For example, such dynamic short code policy 105 may specify that MDNs, IP addresses, and/or other suitable identifiers of such UEs 101 should be provided to communication endpoint 107. Identifying that the messages should be forwarded to communication endpoint 107 may include tracking, by wireless network 103, usage information associated with the particular short code, such as a quantity of voice call requests and/or SMS messages received that specify the particular short code.

Based on the tracking, wireless network 103 may be able to forward (at 304) the identifiers of such UEs 101 to communication endpoint 107. In some embodiments, wireless network 103 may output (at 306) confirmation messages to UEs 101 that were within the first 100 communications (e.g., dialed voice call requests, SMS messages, etc.). The confirmation messages may be SMS messages, system-level notifications, and/or some other type of message.

Additionally, wireless network 103 may further be able to identify that communications (e.g., dialed voice call requests or SMS messages), that specify the particular short code and are received after the first 100 communications are received, should not be forwarded to communication endpoint 107 (e.g., should be rejected and/or should be forwarded to some other device or system). For example, wireless network 103 may receive (at 308) a 101st communication (e.g., a dialed voice call request or an SMS message) that specifies the particular short code. As dynamic short code policies 105 indicate that only UE information for the first 100 communications specifying this short code should be sent to communication endpoint 107, wireless network 103 may proceed to reject (at 310) the communication (received at 308). For example, wireless network 103 may output (at 310) a rejection message (e.g., an SMS message, a system-level notification, and/or some other type of message), indicating that the received communication was not within the first 100 voice call requests or SMS messages. In some embodiments, the rejection message may include a custom message that is specified in dynamic short code policies 105, such as "Sorry, your message was not in the first 100 messages received!" or "Sorry, your call was not in the first 100 calls received!"

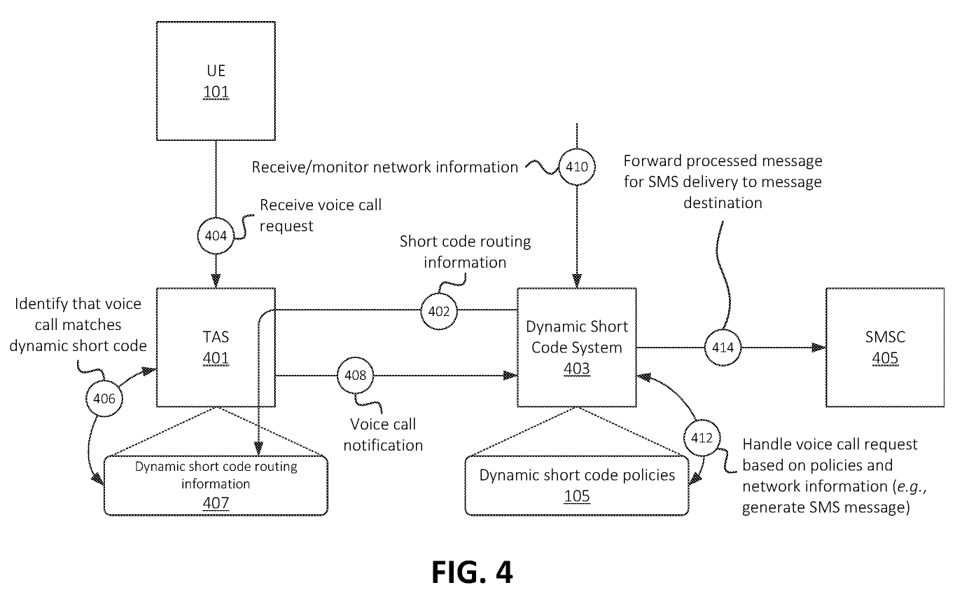

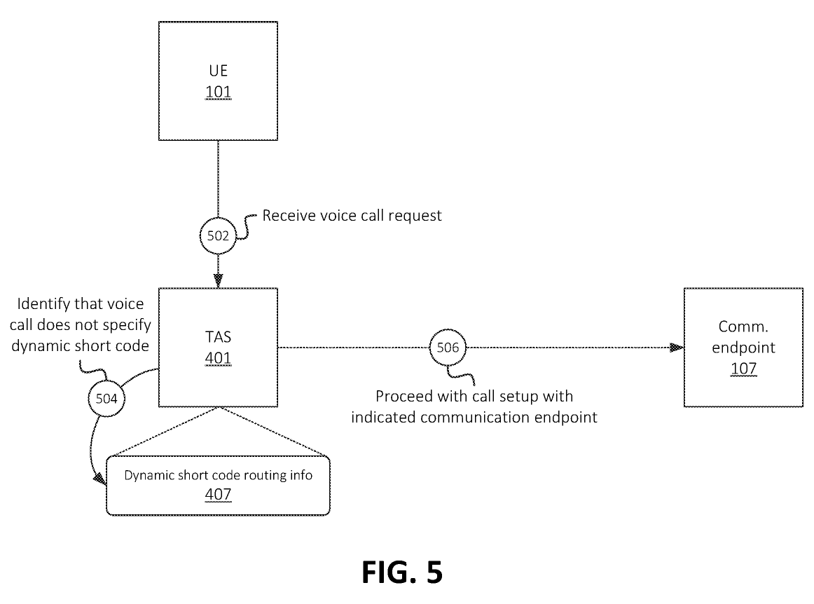

FIGS. 4 and 5 illustrate example policy-based communication routing as performed by example elements of wireless network 103, and/or by devices or systems that are communicatively coupled to wireless network 103. As shown, wireless network 103 may include or may be communicatively coupled to TAS 401, Dynamic Short Code System ("DSCS") 403, and SMSC 405. In one example implementation, TAS 401 may receive (at 402) short code routing information 407 from DSCS 403. Dynamic short code routing information 407 may specify, for example, specific short codes and/or attributes of short codes (e.g., prefixes, patterns, etc.) for which one or more dynamic short code policies 105 apply. In some embodiments, dynamic short code routing information 407 may include an identifier, address, etc. of DSCS 403 (e.g., an MDN, an IP address, a SIP address, or the like). In this manner, multiple short codes may be specified, by dynamic short code routing information 407, as being short codes for which messages should be routed, by TAS 401, to DSCS 403 (e.g., for further processing, such as policy-based routing as discussed above).

TAS 401 may, for example, receive (at 404) a voice call request, such as a voice call request that may have originated from a particular UE 101 (e.g., based on a user dialing a set of numbers at UE 101). TAS 401 may identify (at 406) that the voice call request satisfies one or more conditions, criteria, etc. specified by dynamic short code routing information 407 (e.g., the short code associated with the message is a dynamic short code). For example, TAS 401 may identify that the short code includes a prefix specified by dynamic short code routing information 407, is an exact match of a short code specified by dynamic short code routing information 407, matches a regular expression specified by dynamic short code routing information 407, etc.

Based on identifying (at 406) that the short code is a dynamic short code, TAS 401 may output (at 408) a voice call notification to DSCS 403 (e.g., using an identifier of DSCS 403 and/or via some a suitable interface between TAS 401 and DSCS 403). In some embodiments, the voice call notification may include an identifier of UE 101, such as an MDN, an IP address, etc. In some embodiments, the voice call notification may include other suitable information, such as a time the call request was received or some other suitable information.

DSCS 403 may further receive or monitor (at 410) network information. For example, DSCS 403 may be an element of, and/or may be communicatively coupled to, one or more wireless networks 103. In some embodiments, DSCS 403 may be communicatively coupled to a particular wireless network 103 via a Network Exposure Function ("NEF"), a Service Capability Exposure Function ("SCEF"), or some other interface or suitable communication pathway. The network information may include, for example, UE location information, UE attribute information, and/or other UE information associated with a particular UE 101 from which the message was originally sent. In some embodiments, DSCS 403 may request the network information from wireless network 103 after receiving (at 408) the message. In some embodiments, DSCS 403 may receive or monitor UE information, associated with one or more UEs 101, from wireless network 103 on an ongoing basis (e.g., independently of, or asynchronously with respect to, receiving any messages from any UEs 101).

DSCS 403 may handle or process (at 412) the voice call request based on dynamic short code policies 105 and further based on the received (at 410) network information. In one example, handling or processing the call request may include generating an SMS message (e.g., to a particular communication endpoint 107 and/or to UE 101 from which the call request was received), and sending (at 414) the SMS message to SMSC 405 for forwarding to a destination of the SMS message. The SMS message may include, for example, a confirmation or rejection message, which may include a custom message specified by a respective dynamic short code policy 105. As another example, as discussed above, the SMS message may include one or more identifiers of UE 101 (e.g., in examples where the SMS message is sent to a particular communication endpoint 107). Identifying the identified communication endpoint 107 may include, for example, identifying an MDN, IP address, SIP address, or other suitable identifier of the identified communication endpoint 107 (e.g., based on one or more dynamic short code policies 105).

In some embodiments, SMSC 405 may perform similar operations as described above with respect to TAS 401 in situations where an SMS message is received from UE 101. For example, SMSC 405 may receive an SMS message from UE 101, identify that the SMS message specifies a particular short code as a recipient of the SMS message, and may forward the SMS message to DSCS 403. DSCS 403 may perform one or more operations based on dynamic short code policies 105, such as modifying the content of the message, such as performing content filtering, augmenting the message to include additional information (e.g., as specified by dynamic short code policies 105), and/or other types of processing or modifications. SMSC 405 may proceed to forward the processed message to a given communication endpoint 107, may output a confirmation or rejection message to UE 101, and/or may perform other suitable processing.

In some embodiments, as shown in FIG. 5, TAS 401 may forgo notifying DSCS 403 of certain dialed call requests. For example, as similarly noted above, TAS 401 may maintain dynamic short code routing information 407. When receiving (at 502) a voice call request that does not specify a dynamic short code (e.g., as determined by TAS 401 at 504 based on dynamic short code routing information 407), TAS 401 may proceed (at 506) with a voice call setup between UE 101 and a particular communication endpoint 107 specified in the voice call request. That is, TAS 401 may output (e.g., at 408) notifications of voice call requests that include or specify a short code to DSCS 403, and may instead proceed (e.g., at 506) with a call setup procedure for voice call requests that do not include or do not specify a short code. When proceeding with such call setup procedure for call requests that do not include a dynamic short code, TAS 401 may identify a suitable communication endpoint 107 for such messages. For example, TAS 401 may be configured with mapping information or other information that indicates identifiers (e.g., MDNs, IP addresses, SIP addresses, and/or other types of identifiers that are different from short codes) that are associated with respective dynamic short codes. Such mapping information may, in some embodiments, not be policy-based or dynamic, inasmuch as the routing based on such short codes may be performed without evaluating dynamic short code policies 105 and/or network information.

Although TAS 401 and DSCS 403 are described above as separate devices or systems, in some embodiments one single device or system may perform the functionality described above with respect to TAS 401 and DSCS 403. For example, in some embodiments, TAS 401 may maintain one or more dynamic short code policies 105 and may perform processing of messages based on such dynamic short code policies 105. Similarly, although SMSC 405 and DSCS 403 are described above as separate devices or systems, in some embodiments one single device or system may perform the functionality described above with respect to SMSC 405 and DSCS 403. For example, in some embodiments, SMSC 405 may maintain one or more dynamic short code policies 105 and may perform processing of messages based on such dynamic short code policies 105.

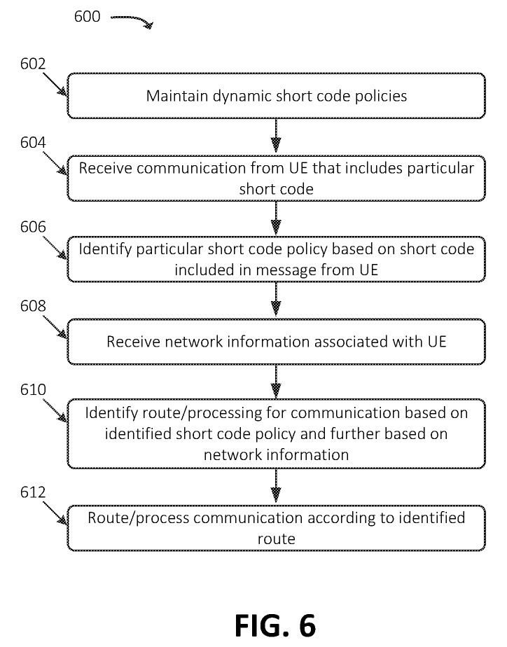

FIG. 6 illustrates an example process 600 for dynamic short code message routing, in accordance with some embodiments. In some embodiments, some or all of process 600 may be performed by DSCS 403. In some embodiments, one or more other devices may perform some or all of process 600 in concert with and/or in lieu of DSCS 403 (e.g., TAS 401). As discussed above, TAS 401 may perform some or all of the operations described below with respect to DSCS 403.

As shown, process 600 may include maintaining (at 602) a set of dynamic short code policies 105. For example, as discussed above, DSCS 403 may receive dynamic short code policies 105 from an MNO, may generate or refine dynamic short code policies 105 using AI/ML techniques or other automated techniques, and/or may otherwise receive and maintain dynamic short code policies 105. Dynamic short code policies 105 may include message routing policies, content filtering or augmentation policies, and/or other suitable types of policies, temporal policies, and/or other types of policies, as discussed above.

Process 600 may further include receiving (at 604) a communication, from a particular UE 101, that includes a particular short code. For example, the communication may be a voice call request or an SMS message, where a specified recipient or destination of the communication is specified using a particular short code. As noted above, the short code may include fewer digits, characters, etc. than other types of codes or identifiers used for message routing in in wireless network 103 (e.g., MDNs, IP addresses, SIP addresses, or the like).

Process 600 may additionally include identifying (at 606) a particular short code policy 105 that is applicable to the particular short code. For example, as discussed above, different short codes may be associated with different policies, and DSCS 403 may identify, for the messaged received from UE 101 (at 602), a particular short code policy 105 (or set of dynamic short code policies 105) that are applicable based on the short code specified in the communication.

Process 600 may also include receiving (at 608) network information associated with UE 101, from which the communication was received. For example, as discussed above, DSCS 403 may receive (e.g., via a SCEF, a NEF, etc.) UE information such as UE device type, UE location, and/or other UE information. In some embodiments, DSCS 403 may receive other types of network information, such as network load information, network performance information, and/or other types of information (e.g., information that may be specified as criteria or conditions by one or more dynamic short code policies 105). In some embodiments, DSCS 403 may receive or identify other types of information, such as temporal information (e.g., a current time of day, a current day of the week, etc.).

Process 600 may further include identifying (at 610) a route and/or other processing for the communication based on the identified short code policy (or policies) 105, and further based on the received network information. For example, as discussed above, dynamic short code policies 105 may specify particular communication endpoints 107 (e.g., MDNs, IP addresses, SIP addresses, hostnames, or the like) to which communications that meet certain criteria or conditions should be routed. As discussed above, DSCS 403 may further identify other processing operations based on dynamic short code policies 105, such as modifying or augmenting content of a received SMS message based on whether certain criteria or conditions are met. As another example, as discussed above, DSCS 403 may identify that a particular communication endpoint 107 should be notified that the communication (e.g., a voice call request or SMS message) was received from UE 101. As discussed above, other processing may include operations such as generating a message based on the communication (e.g., generating an SMS message based on a voice call request, generating a second message based on a first SMS message received from UE 101, augmenting or modifying an SMS message received from UE 101, etc.). In some embodiments, the processing may include generating a confirmation or rejection message, as discussed above.

Process 600 may additionally include routing and/or processing (at 612) the communication according to the identified route. For example, if the communication includes an SMS message, DSCS 403 may forward the SMS message toward an identified communication endpoint 107, which may include forwarding the message to a particular SMSC 405. In some embodiments, forwarding the message may include specifying an MDN, IP address, or other suitable identifier of communication endpoint 107, based on which SMSC 405 may proceed to forward (e.g., as an SMS message) the message from UE 101. In such implementations, communication endpoint 107 may perform further processing, such as providing a service to UE 101, modifying UE information, actuating an IoT device, and/or performing other suitable operations. As another example, DSCS 403 may instruct TAS 401 to establish a voice call between UE 101 and the identified communication endpoint 107 (e.g., in scenarios where the communication from UE 101 includes a voice call request).

As discussed above, in some embodiments, processing the communication may include generating an additional communication, such as a confirmation or rejection message. Processing the communication may further include providing the additional communication (e.g., via an SMS message, a system-level notification, etc.) to UE 101.

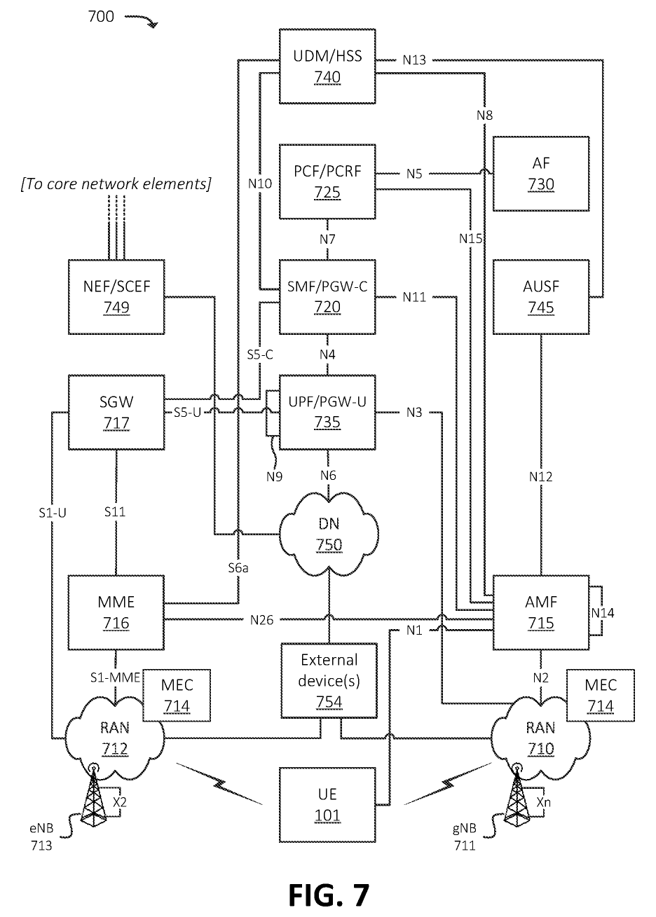

FIG. 7 illustrates an example environment 700, in which one or more embodiments may be implemented. In some embodiments, environment 700 may correspond to a Fifth Generation ("5G") network, and/or may include elements of a 5G network. In some embodiments, environment 700 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 700 may represent or may include a 5G core ("5GC"). As shown, environment 700 may include UE 101, RAN 710 (which may include one or more Next Generation Node Bs ("gNBs") 711), RAN 712 (which may include one or more evolved Node Bs ("eNBs") 713), and various network functions such as AMF 715, MME 716, Serving Gateway ("SGW") 717, Session Management Function ("SMF")/Packet Data Network ("PDN") Gateway ("PGW")-Control plane function ("PGW-C") 720, Policy Control Function ("PCF")/Policy Charging and Rules Function ("PCRF") 725, Application Function ("AF") 730, User Plane Function ("UPF")/PGW-User plane function ("PGW-U") 735, UDM/HSS 740, Authentication Server Function ("AUSF") 745, and NEF/SCEF 749. Environment 700 may also include one or more networks, such as Data Network ("DN") 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple "slices" of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service ("QoS") parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions ("VNFs"), Cloud-Native Network Functions ("CNFs"), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes^{®} application programming interface ("API") or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces ("SBIs"), including an Namf interface, an Nudm interface, an Npcf interface, an Nupf interface, an Nnef interface, an Nsmf interface, and/or one or more other SBIs. In some embodiments, environment 700 may be, may include, may be implemented by, and/or may be communicatively coupled to wireless network 103.

UE 101 may include a computation and communication device, such as a wireless mobile communication device that is capable of communicating with RAN 710, RAN 712, and/or DN 750. UE 101 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 101 may send traffic to and/or receive traffic (e.g., user plane traffic) from DN 750 via RAN 710, RAN 712, and/or UPF/PGW-U 735.

RAN 710 may be, or may include, a 5G RAN that implements a 5G RAT and that includes one or more base stations (e.g., one or more gNBs 711), via which UE 101 may communicate with one or more other elements of environment 700. UE 101 may communicate with RAN 710 via an air interface (e.g., as provided by gNB 711). For instance, RAN 710 may receive traffic (e.g., user plane traffic such as voice call traffic, data traffic, messaging traffic, etc.) from UE 101 via the air interface, and may communicate the traffic to UPF/PGW-U 735 and/or one or more other devices or networks. Further, RAN 710 may receive signaling traffic, control plane traffic, etc. from UE 101 via the air interface, and may communicate such signaling traffic, control plane traffic, etc. to AMF 715 and/or one or more other devices or networks. Additionally, RAN 710 may receive traffic intended for UE 101 (e.g., from UPF/PGW-U 735, AMF 715, and/or one or more other devices or networks) and may communicate the traffic to UE 101 via the air interface.

RAN 712 may be, or may include, an LTE RAN that implements an LTE RAT and that includes one or more base stations (e.g., one or more eNBs 713), via which UE 101 may communicate with one or more other elements of environment 700. UE 101 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 101 via the air interface, and may communicate the traffic to UPF/PGW-U 735 (e.g., via SGW 717) and/or one or more other devices or networks. Further, RAN 712 may receive signaling traffic, control plane traffic, etc. from UE 101 via the air interface, and may communicate such signaling traffic, control plane traffic, etc. to MME 716 and/or one or more other devices or networks. Additionally, RAN 712 may receive traffic intended for UE 101 (e.g., from UPF/PGW-U 735, MME 716, SGW 717, and/or one or more other devices or networks) and may communicate the traffic to UE 101 via the air interface.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing ("MEC") devices (referred to sometimes herein simply as a "MECs") 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 101, via RAN 710 and/or 712. For example, RAN 710 and/or 712 may route some traffic from UE 101 (e.g., traffic associated with one or more particular services, applications, application types, etc.) to a respective MEC 714 instead of to core network elements of 700 (e.g., UPF/PGW-U 735). MEC 714 may accordingly provide services to UE 101 by processing such traffic, performing one or more computations based on the received traffic, and providing traffic to UE 101 via RAN 710 and/or 712. MEC 714 may include, and/or may implement, some or all of the functionality described above with respect to UPF/PGW-U 735, AF 730, communication endpoint 107, TAS 401, DSCS 403, SMSC 405, one or more application servers, and/or one or more other devices, systems, VNFs, CNFs, etc. In this manner, ultra-low latency services may be provided to UE 101, as traffic does not need to traverse links (e.g., backhaul links) between RAN 710 and/or 712 and the core network.

AMF 715 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 710 and/or gNBs 711, and/or to perform other operations. In some embodiments, the 5G network may include multiple AMFs 715, which communicate with each other via the N14 interface (denoted in FIG. 7 by the line marked "N14" originating and terminating at AMF 715).

MME 716 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 101. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 101, from DN 750, and may forward the user plane data toward UE 101 (e.g., via RAN 710, SMF/PGW-C 720, and/or one or more other devices). In some embodiments, multiple instances of UPF/PGW-U 735 may be deployed (e.g., in different geographical locations), and the delivery of content to UE 101 may be coordinated via the N9 interface (e.g., as denoted in FIG. 7 by the line marked "N9" originating and terminating at UPF/PGW-U 735). Similarly, UPF/PGW-U 735 may receive traffic from UE 101 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a Unified Data Repository ("UDR"). AUSF 745 and/or UDM/HSS 740 may perform authentication, authorization, and/or accounting operations associated with one or more UEs 101 and/or one or more communication sessions associated with one or more UEs 101.

DN 750 may include one or more wired and/or wireless networks. For example, DN 750 may include an Internet Protocol ("IP")-based PDN, a wide area network ("WAN") such as the Internet, a private enterprise network, and/or one or more other networks. UE 101 may communicate, through DN 750, with data servers, other UEs 101, and/or to other servers or applications that are coupled to DN 750. DN 750 may be connected to one or more other networks, such as a public switched telephone network ("PSTN"), a public land mobile network ("PLMN"), and/or another network. DN 750 may be connected to one or more devices, such as content providers, applications, web servers, and/or other devices, with which UE 101 may communicate.

External devices 754 may include one or more devices or systems that communicate with UE 101 via DN 750 and one or more elements of 700 (e.g., via UPF/PGW-U 735). In some embodiments, external devices 754 may include, may implement, and/or may otherwise be associated with communication endpoint 107, TAS 401, DSCS 403, and/or SMSC 405. External devices 754 may include, for example, one or more application servers, content provider systems, web servers, or the like. External devices 754 may, for example, implement "server-side" applications that communicate with "client-side" applications executed by UE 101. External devices 754 may provide services to UE 101 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy ("SEPP"), which may perform some or all of the functions discussed above. External device 754 may, in some situations, subscribe to particular types of requested information provided by the one or more core network elements, and the one or more core network elements may provide (e.g., "push") the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements ("SLAs"), etc. (e.g., maximum latency thresholds, minimum throughput thresholds, etc.) associated with the services.

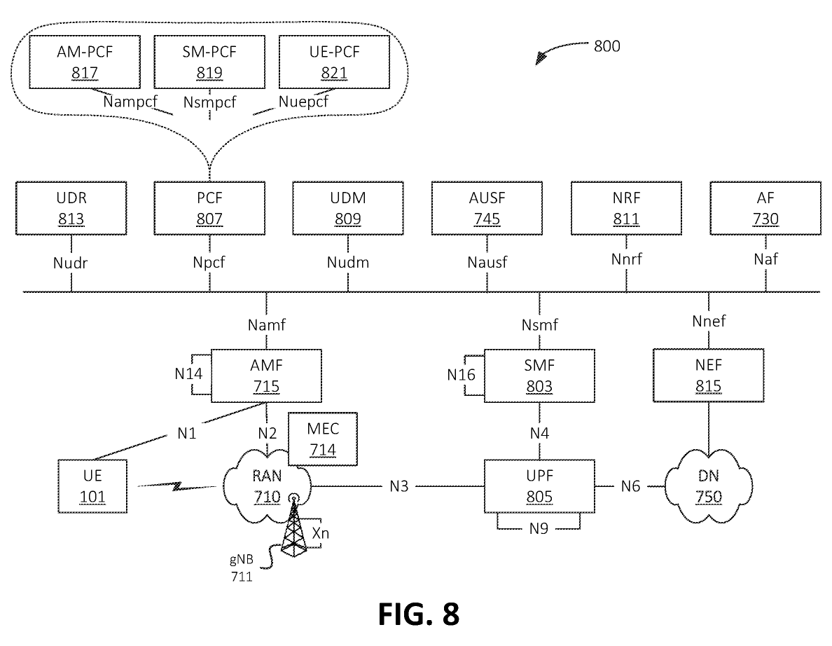

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 101, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function ("NRF") 811, AF 730, UDR 813, and NEF 815. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple "slices" of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs. In some embodiments, environment 800 may be, may include, may be implemented by, and/or may be communicatively coupled to wireless network 103.

UPF 805 may include one or more devices, systems, VNFs, CNFs, etc., that receive, route, process, and/or forward traffic (e.g., user plane traffic). As discussed above, UPF 805 may communicate with UE 101 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 101) from DN 750, and may forward the downlink user plane traffic toward UE 101 (e.g., via RAN 710). In some embodiments, multiple UPFs 805 may be deployed (e.g., in different geographical locations), and the delivery of content to UE 101 may be coordinated via the N9 interface. Similarly, UPF 805 may receive uplink traffic from UE 101 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 101 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as access and mobility PCF ("AM-PCF") 817, session management PCF ("SM-PCF") 819, UE PCF ("UE-PCF") 821, and so on. Such different "split" PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 815 include one or more devices, systems, VNFs, CNFs, etc. that provide access to information, APIs, and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function ("CHF") of the 5GC, and/or other suitable network function. NEF 815 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 815 may include, may implement, may be implemented by, and/or may otherwise be associated with a SCEF (e.g., NEF/SCEF 749); and so on.

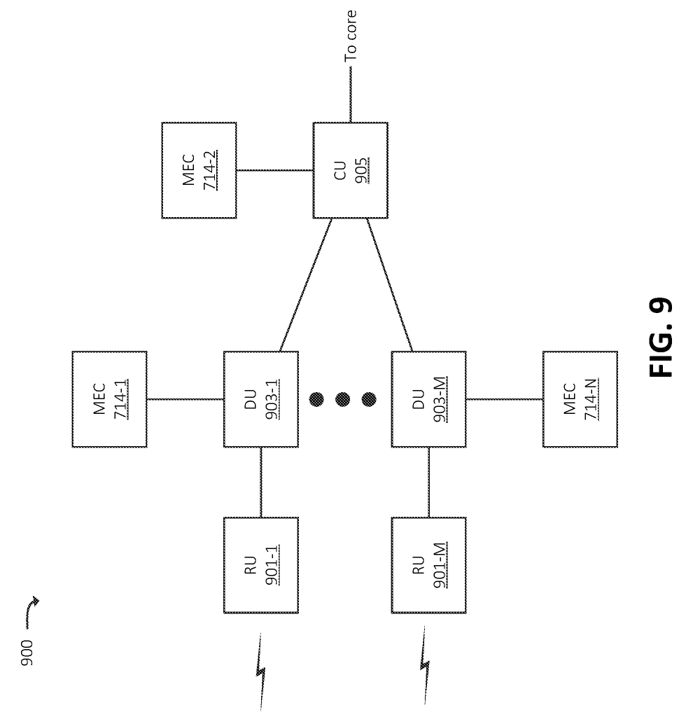

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit ("CU") 905, one or more Distributed Units ("DUs") 903-1 through 903-M (referred to individually as "DU 903," or collectively as "DUs 903"), and one or more Radio Units ("RUs") 901-1 through 901-M (referred to individually as "RU 901," or collectively as "RUs 901").

CU 905 may communicate with a core of a wireless network (e.g., may communicate with one or more of the devices or systems described above with respect to FIG. 8, such as AMF 715 and/or UPF 805) and/or some other device or system such as MEC 714. In the uplink direction (e.g., for traffic from UEs 101 to a core network), CU 905 may aggregate traffic from DUs 903, and forward the aggregated traffic to the core network. In some embodiments, CU 905 may receive traffic according to a given protocol (e.g., Radio Link Control ("RLC") traffic) from DUs 903, and may perform higher-layer processing (e.g., may aggregate/process RLC packets and generate Packet Data Convergence Protocol ("PDCP") packets based on the RLC packets) on the traffic received from DUs 903.

CU 905 may receive downlink traffic (e.g., traffic from the core network, traffic from a given MEC 714, etc.) for a particular UE 101, and may determine which DU(s) 903 should receive the downlink traffic. DU 903 may include one or more devices that transmit traffic between a core network (e.g., via CU 905) and UE 101 (e.g., via a respective RU 901). DU 903 may, for example, receive traffic from RU 901 at a first layer (e.g., physical ("PHY") layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 101.

RU 901 may include hardware circuitry (e.g., one or more RF transceivers, antennas, radios, and/or other suitable hardware) to communicate wirelessly (e.g., via an RF interface) with one or more UEs 101, one or more other DUs 903 (e.g., via RUs 901 associated with DUs 903), and/or any other suitable type of device. In the uplink direction, RU 901 may receive traffic from UE 101 and/or another DU 903 via the RF interface and may provide the traffic to DU 903. In the downlink direction, RU 901 may receive traffic from DU 903, and may provide the traffic to UE 101 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 101, via a respective RU 901.

For example, DU 903-1 may route some traffic, from UE 101, to MEC 714-1 instead of to a core network via CU 905. MEC 714-1 may process the traffic, perform one or more computations based on the received traffic, and may provide traffic to UE 101 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 101, as traffic does not need to traverse DU 903, CU 905, links between DU 903 and CU 905, and an intervening backhaul network between RAN environment 900 and the core network.

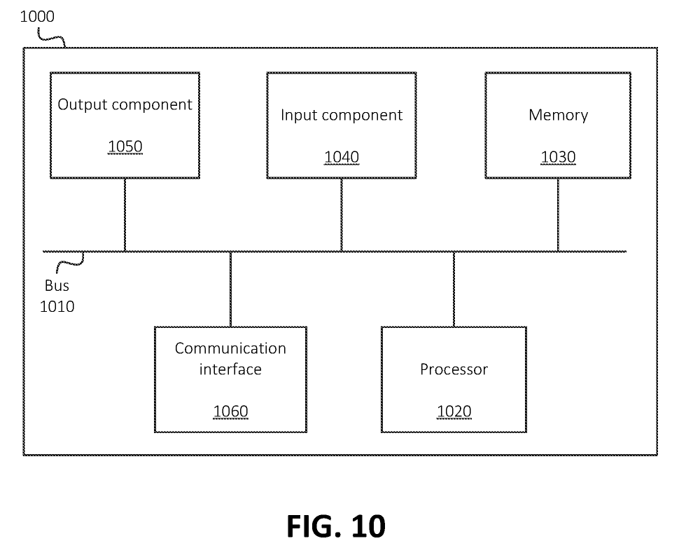

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes ("LEDs"), etc.

Communication interface 1060 may include any transceiver-like mechanism that enables device 1000 to communicate with other devices and/or systems (e.g., via RAN 710, RAN 712, DN 750, etc.). For example, communication interface 1060 may include an Ethernet interface, an optical interface, a coaxial interface, or the like. Communication interface 1060 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
maintain a set of policies associated with a plurality of codes;
receive a communication from a User Equipment ("UE"), wherein the communication includes a particular code of the plurality of codes;
identify a particular policy, of the set of policies, associated with the particular code;
receive, from a particular wireless network, network information associated with the UE;
identify a route for the communication based on the particular policy and the received network information; and
route the communication based on the route that was identified based on the particular policy and the received network information.

2. The device of claim 1, wherein receiving the network information includes receiving the network information via at least one of:
a Network Exposure Function ("NEF") of the particular network, or
a Service Capability Exposure Function ("SCEF") of the particular wireless network.

3. The device of claim 1, wherein the network information includes one or more UE attributes.

4. The device of claim 3, wherein the network information is provided by at least one of:
a Home Subscriber Server ("HSS") of the particular wireless network,
a Unified Data Management function ("UDM") of the particular wireless network, or
a Unified Data Repository ("UDR") of the particular wireless network.

5. The device of claim 1, wherein the communication includes at least one of:
a voice call request, or
a Short Message Service ("SMS") message.

6. The device of claim 1, wherein the particular code is a short code that includes fewer characters than Mobile Directory Numbers ("MDNs") used by the particular wireless network to route communications.

7. The device of claim 1, wherein routing the communication includes selecting a particular communication endpoint, out of a plurality of candidate communication endpoints, and routing the communication to the particular communication endpoint.

8. A non-transitory computer-readable medium, storing a plurality of processor-executable instructions to:
maintain a set of policies associated with a plurality of codes;
receive a communication from a User Equipment ("UE"), wherein the communication includes a particular code of the plurality of codes;
identify a particular policy, of the set of policies, associated with the particular code;
receive, from a particular wireless network, network information associated with the UE;
identify a route for the communication based on the particular policy and the received network information; and
route the communication based on the route that was identified based on the particular policy and the received network information.

9. The non-transitory computer-readable medium of claim 8, wherein receiving the network information includes receiving the network information via at least one of:
a Network Exposure Function ("NEF") of the particular network, or
a Service Capability Exposure Function ("SCEF") of the particular wireless network.

10. The non-transitory computer-readable medium of claim 8, wherein the network information includes one or more UE attributes.

11. The non-transitory computer-readable medium of claim 10, wherein the network information is provided by at least one of:
a Home Subscriber Server ("HSS") of the particular wireless network,
a Unified Data Management function ("UDM") of the particular wireless network, or
a Unified Data Repository ("UDR") of the particular wireless network.

12. The non-transitory computer-readable medium of claim 8, wherein the communication includes at least one of:
a voice call request, or
a Short Message Service ("SMS") message.

13. The non-transitory computer-readable medium of claim 8, wherein the particular code is a short code that includes fewer characters than Mobile Directory Numbers ("MDNs") used by the particular wireless network to route communications.

14. The non-transitory computer-readable medium of claim 8, wherein routing the communication includes selecting a particular communication endpoint, out of a plurality of candidate communication endpoints, and routing the communication to the particular communication endpoint.

15. A method, comprising:
maintaining a set of policies associated with a plurality of codes;
receiving a communication from a User Equipment ("UE"), wherein the communication includes a particular code of the plurality of codes;
identifying a particular policy, of the set of policies, associated with the particular code;
receiving, from a particular wireless network, network information associated with the UE;
identifying a route for the communication based on the particular policy and the received network information; and
routing the communication based on the route that was identified based on the particular policy and the received network information.

16. The method of claim 15, wherein receiving the network information includes receiving the network information via at least one of:
a Network Exposure Function ("NEF") of the particular network, or
a Service Capability Exposure Function ("SCEF") of the particular wireless network.

17. The method of claim 15, wherein the network information includes one or more UE attributes, wherein the network information is provided by at least one of:
a Home Subscriber Server ("HSS") of the particular wireless network,
a Unified Data Management function ("UDM") of the particular wireless network, or
a Unified Data Repository ("UDR") of the particular wireless network.

18. The method of claim 15, wherein the communication includes at least one of:
a voice call request, or
a Short Message Service ("SMS") message.

19. The method of claim 15, wherein the particular code is a short code that includes fewer characters than Mobile Directory Numbers ("MDNs") used by the particular wireless network to route communications.

20. The method of claim 15, wherein routing the communication includes selecting a particular communication endpoint, out of a plurality of candidate communication endpoints, and routing the communication to the particular communication endpoint.
